(19) United States
(12) Patent Application Publication
(10) Pub. No.: US 2017/0059711 A1
(43) Pub. Date: Mar. 2, 2017

(54) ND:YAG OSCILLATOR-BASED THREE WAVELENGTH LASER SYSTEM

(71) Applicant: U.S.A. as represented by the Administrator of the National Aeronautics and Space Administration, Washington, DC (US)

(72) Inventors: Paul R. Stysley, Catonsville, MD (US); Donald B. Coyle, Ellicott City, MD (US)

(21) Appl. No.: 14/841,176

(22) Filed: Aug. 31, 2015

(51) Int. Cl. G01S 17/88; H01S 3/16; G01S 7/483; H01S 3/06; B64G 1/10; G01N 21/47; H01S 3/0941; H01S 3/08

(52) U.S. Cl. CPC G01S 17/88; H01S 3/0941; H01S 3/1611; H01S 3/1643; H01S 3/08063; H01S 3/08095; H01S 3/08054; H01S 3/0606; H01S 3/0615; B64G 1/1021; G01N 21/4738; G01S 7/483; B64G 2001/1028; B64G 2001/1042; G01N 2201/06113

(57) ABSTRACT

A laser system is provided that includes a master oscillator, a pre-amplifier, a power amplifier, a beam doubler, and a beam tripler. The laser system is configured to generate three different wavelengths, including, for example, wavelengths of 1064 nm, 532 nm, and 355 nm. The pre-amplifier can be optically aligned along a beam path exiting the master oscillator, to receive and pre-amplify a laser beam generated by the master oscillator. The amplifier can be optically aligned along a beam path exiting the pre-amplifier, and can be configured to receive a pre-amplified laser beam generated by the pre-amplifier. The beam doubler and beam tripler can be optically aligned along a beam path exiting the amplifier and can be configured to double and triple, respectively, an amplified laser beam generated by the amplifier.

### STATEMENT REGARDING FEDERALLY SPONSORED RESEARCH OR DEVELOPMENT

The invention described herein was made in part by employees of the United States Government and may be manufactured and used by or for the Government of the United States of America for governmental purposes without the payment of any royalties thereon or therefore.

### FIELD OF THE INVENTION

The present invention relates to a laser system for producing high power laser pulses.

### BACKGROUND OF THE INVENTION

In the NRC Decadal Survey on Earth Science and Applications, LIDARs are identified as the primary instrumentation for several missions NASA plans to launch between 2013 and 2020. These missions will use LIDAR to measure global wind fields, aerosol profiles, clouds, and ocean color. The 2008 International Geoscience & Remote Sensing Symposium (IGARSS) called for NASA proposals addressing the need for more powerful, more energy-efficient and more reliable lasers in order to realize the full potential of tropospheric wind LIDARs for scientific research and applications.

NASA's Decadal Survey for Earth Science identifies the 3D Tropospheric Winds (3D Winds) mission and the Aerosols, Clouds, and Ecosystems (ACE) mission as critical missions for NASA's near future. The missions have in common the dependence on high power, pulsed laser transmitters. The ACE instrument will require stabilized backscatter wavelengths of 1064 nm, 532 nm, and 355 nm for its aerosol-tracking scheme. Also, due to the fact that the scattering efficiency off of atmospheric molecules is proportional to (1/λ)4, the 3D Winds instrument will require an output of up to 400 mJ per pulse in the ultraviolet region at 355 nm.

3D Winds measurement of global tropospheric wind profiles will advance the ability to predict and understand weather phenomena from the tropics to the poles. Except for the unevenly distributed single-level measurements at the surface by buoys, aircraft, and ships and the very few profile measurements from radiosonde stations primarily over land, the vertical structure of the horizontal wind field profile measurements are lacking. Satellite-based cloud drift inferred wind measurements are available but have fairly large errors in the wind measurement itself and the height allocation of the measurements is suspect. A capability to observe directly the global wind fields would be extremely valuable for numerical weather prediction, as well as scientific diagnostics of large-scale atmospheric transport, weather systems, and boundary layer dynamics in Earth's atmosphere.

### SUMMARY OF THE INVENTION

According to various embodiments of the present invention, the laser system provided is comprised of a master oscillator, a pre-amplifier, a power amplifier, a frequency doubler, and a frequency tripler. The laser system is configured to generate three different wavelengths, for example, wavelengths of 1064 nm, 532 nm, and 355 nm. The pre-amplifier can be optically aligned along a beam path exiting the master oscillator, to receive and pre-amplify a laser beam generated by the master oscillator. The power amplifier can be optically aligned along a beam path exiting the pre-amplifier, and can be configured to receive a pre-amplified laser beam generated by the pre-amplifier, and further amplify it. The beam doubler and beam tripler can be optically aligned along a beam path exiting the power amplifier and can be configured to double and triple, respectively, an amplified laser beam. The laser system is configured to produce pulse energies at 1064 nm of about 1 J, and can double or triple the pulse energies to instead produce wavelengths of 532 nm and 355 nm, respectively.

The present invention provides a stable, high power laser oscillator and amplifier with a low part count and high efficiency. The High Efficiency Amplified Twin Head (HEATH) laser system of the present invention (the HEATH laser) is shown in FIG. 4. The HEATH laser provides NASA with a Q-switched laser system capable of demonstrating spaceflight level performance in key areas such as high power, damage-free operation, single frequency pulses, and efficient second and third harmonic generation. Both the 3D Winds mission and the ACE mission can benefit from the same laser technology utilizing additional amplification, single frequency operation and feedback, as well as the 3rd wavelength production capability.

The ACE mission will provide simultaneous measurements of aerosol backscatter radiation and ocean color biosphere measurements by employing a High Spectral Resolution Lidar (HSRL) scheme that requires a laser capable of 3-wavelength production. Within each laser footprint, the data will link the entire size spectrum untangling their impacts and constrain their interaction in order to reduce uncertainties in climate forcing models. By quantifying the biological pump component of carbon sequestration, greater knowledge of the ocean biospheric responses to natural and manmade climate change can result. The ACE aerosol data combined with the 3D Winds data sets will generate powerful tools in predicting the global climate as well as closing the planetary energy budget.

The HEATH system meets the demands of both the ACE and 3D Winds missions in wavelength, power, stability, and lifetime According to the present invention, these two interdependent global climate change missions can greatly benefit from a single technology.

### BRIEF DESCRIPTION OF THE DRAWINGS

The present invention can be even more fully understood with the reference to the accompanying drawings which are intended to illustrate, not limit, the present invention.

FIG. 1 is a schematic, exploded view of the various components of a master oscillator in accordance with various embodiments of the present invention.

FIG. 2 is a top view of an exemplary embodiment of a master oscillator in an enclosure, according to the present invention.

FIG. 3 is a schematic diagram of a lifetest layout that can be used to exemplify a system, in accordance with various embodiments of the present invention, for fully automated data capture and temperature control, providing safe, unattended operation and 114 mJ pulse energies.

FIG. 4 is a schematic diagram of a HEATH laser system according to various embodiments of the present invention.

FIG. 5 is a schematic diagram depicting a satellite survey system for the ACE mission, according to various embodiments of the present invention.

FIG. 6 is a top view of a 100 mJ THEO master oscillator in accordance with another embodiment of the present invention.

FIG. 7 is a block diagram of the Pound-Drever-Hall injection seeding and cavity locking method that can be used in accordance with various embodiments of the present invention.

FIG. 8 is a pair of graphs showings thermal lens calculated results for the power amplifier X and Y axis cross-sections, respectively, wherein each line with circles is a data line and each line with triangles is a parabolic fit.

### DETAILED DESCRIPTION OF THE INVENTION

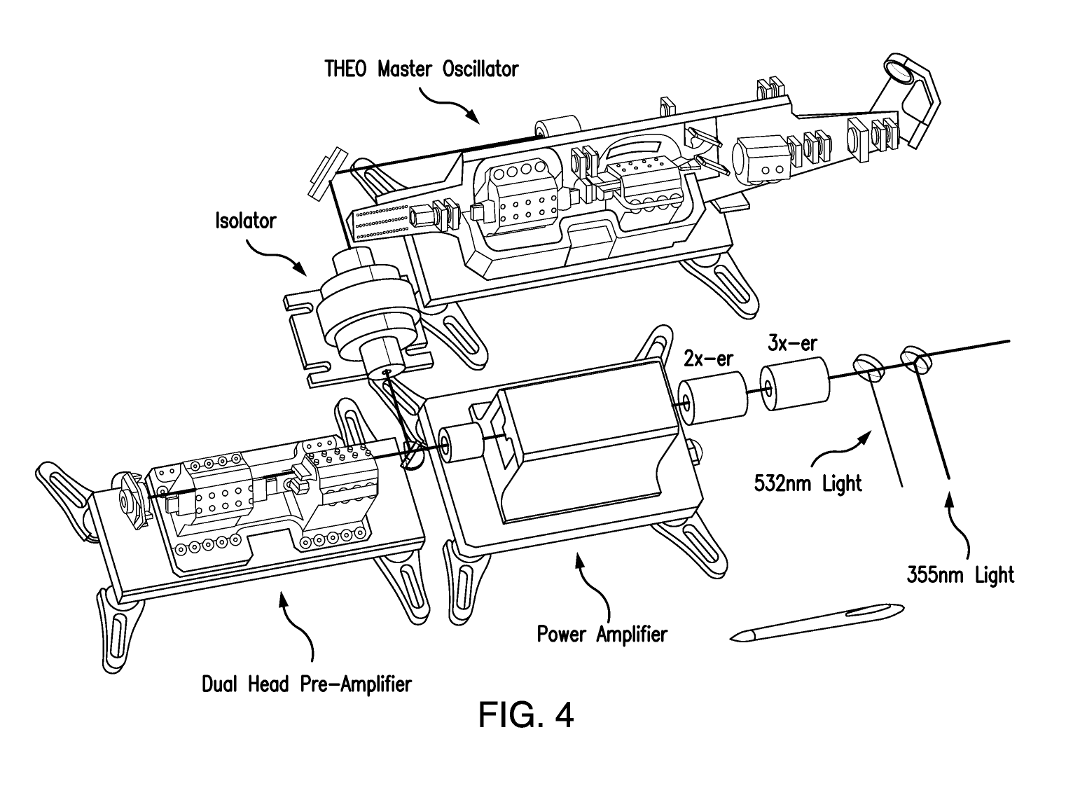

According to various embodiments of the present invention, the laser system comprises a master oscillator, a pre-amplifier, a power amplifier, a frequency doubler, and a frequency tripler, for example, as shown and arranged in FIG. 4. The master oscillator can comprise or consist essentially of a laser head, a ½ wave-plate, a Q-switch, a ¼ wave-plate, a graded reflectivity mirror, a cylindrical lens, a high reflectivity mirror. The laser head is comprised of a diode-side-pumped ND:YAG slab laser configured as a zig-zag slab gain medium. The laser head is configured to produce a laser beam along an optical path. The ½ wave-plate can be aligned along the optical path and configured to polarize a laser beam produced by the laser head, to form a polarized laser beam. The laser head can comprise or consist of a pair of identical laser gain modules, using zigzag laser slabs, side pumped with diode arrays. But using these modules in the orthogonal orientation shown in FIG. 4, the laser cavity produces beam qualities only possible with those using cylindrical laser rods. However, cylindrical rod based cavities cannot produce pulse energies such as the HEATH oscillator and requires liquid contact cooling as well. Thus, the HEATH oscillator performance reduces the total hardware needed to reach 1 J per pulse or more by at least 1 full amplifier stage, over an equivalent system using a rod based oscillator. The Q-switch can be aligned along the optical path and configured to pulse a polarized laser beam polarized by the ½ wave-plate. The ¼ wave-plate can be aligned along the optical path and configured to polarize a pulsed and polarized laser beam formed by the Q-switch. The graded reflectivity mirror can be aligned along the optical path and configured to partially reflect and partially transmit a polarized, pulsed and polarized laser beam produced by the ¼ wave-plate, and to form a reflected laser beam along a reflected optical path. The cylindrical lens can be aligned along the reflected optical path and configured to focus a reflected laser beam. The high reflectivity mirror can be aligned along the reflected optical path and configured to reflect a focused reflected laser beam produced by the cylindrical lens.

The master oscillator can further comprise an enclosure that has a single aperture, and the single aperture can be configured to transmit a polarized, pulsed and polarized laser beam from the graded reflectivity mirror along the optical path to be output from the enclosure, and directed to the pre-amplifier. Other components, arrangements, configurations, and methods using the same, that can be implemented in the laser system include those described, for example, in Coyle et al., High Efficiency, 100 mJ per pulse, Nd: YAG oscillator optimized for space-based earth and planetary remote sensing, Optics & Laser Technology, 63 (2014) 13-18, Elsevier Ltd., which is incorporated herein in its entirety by reference. Other components, arrangements, configurations, and methods using the same, which can be implemented in the laser systems, spacecraft, and missions of the present invention include those as disclosed in U.S. Pat. No. 8,958,452 B2 to Coyle at el., which is incorporated herein in its entirety by reference, and as disclosed in concurrently filed U.S. patent application Ser. No. ______ to Coyle et al. entitled “Ground-based Laser Ranging System for Identification and Tracking of Orbital Debris” (Attorney Docket No. GSC-17295-1), which is incorporated herein in its entirety by reference.

The pre-amplifier of the laser system can comprise a twin head gain configuration that is adapted to or capable of amplifying, by four times, energy produced by the master oscillator. The master oscillator can be configured to produce 120 mJ single frequency laser pulse signals and the pre-amplifier can be configured to amplify the laser pulse signals, for example, by two times, four times, eight times, or the like. The pre-amplifier can be configured to amplify the laser pulse signals by four times to produce amplified signals of about 500 mJ. The pre-amplifier can comprise Nd:YAG slabs, and the Nd:YAG slabs of the pre-amplifier can have Brewster-cut end faces coated with an anti-reflection coating.

The power amplifier, also referred to herein as the amplifier, can be configured to amplify by two times, four times, eight times, or the like, the pre-amplified signals produced by the pre-amplifier. The amplifier can comprise one or more ceramic zigzag slabs. The amplifier gain module, or laser head, consists of the orthogonal units just as in the HEATH laser cavity. This provides both high gain typical of zigzag slabs, but with symmetrical beam quality effects of cylindrical laser rods. The amplifier can comprise a configuration that provides pumping from opposite sides of the ceramic zigzag slab.

According to various embodiments of the present invention, the laser system can be mounted in or on a spacecraft. The present invention also provides a combination of the laser system and a spacecraft. The laser system can be mounted in or on the spacecraft and can be configured to direct laser beam pulses of about 1 J toward the Earth, for example, to irradiate aerosols in the atmosphere above the Earth's surface, or to irradiate a water-covered or ocean-covered portion of the Earth's surface. The laser system can be configured to direct the laser beam pulses at a 532 nm wavelength toward the Earth, or at a 355 nm wavelength toward the Earth. The laser system can be configured to generate laser beams of three different wavelengths, independently, for example, the laser system can be configured to independently generate laser beams at a wavelength of 1064 nm, laser beams at a wavelength of 532 nm, and laser beams at a wavelength of 355 nm. The laser system can be configured to switch between generating the laser beams at the three different wavelengths, for example, to intermittently or periodically provide laser beam pulses at each of the different wavelengths.

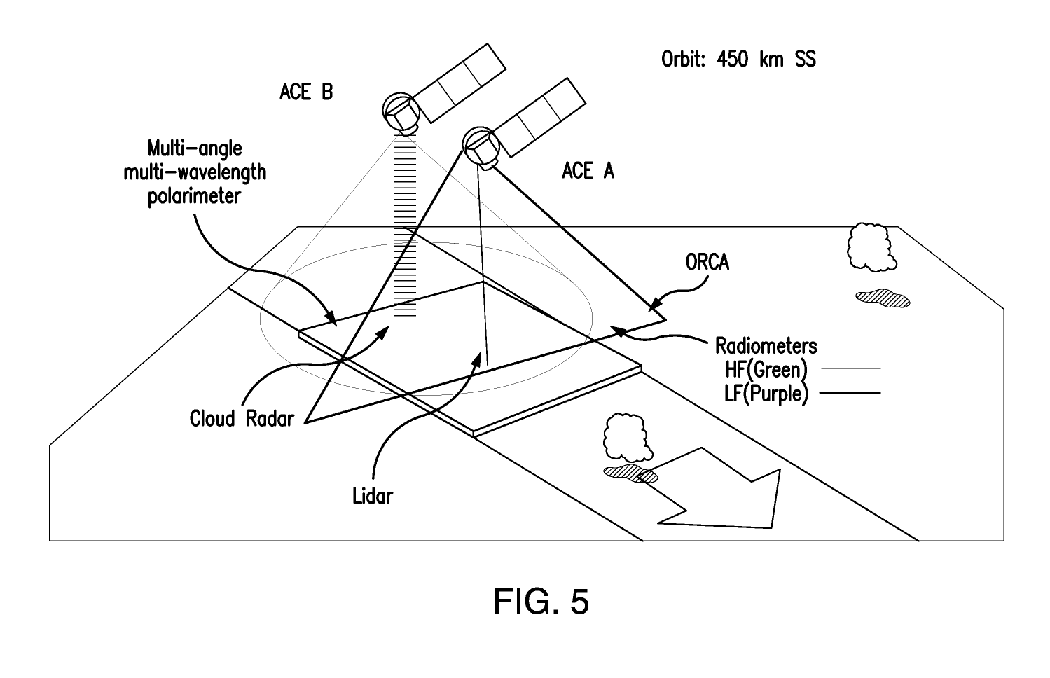

The present invention also provides methods of forming about 1 J laser pulses, by forming laser pulses with the laser system described herein. A method is also provided for analyzing aerosol backscatter radiation, and comprises generating pulsed laser beams with a laser system as described herein, directing such pulsed laser beams from a spacecraft toward an atmosphere over a surface of the Earth, detecting reflected laser light returning to the spacecraft after reflecting off of the atmosphere, and analyzing aerosol backscatter radiation caused by the atmosphere, based on the detected reflected laser light. The generating and directing can comprise producing 1 J TEM₀₀ laser pulses at 1064 nm, at 532 nm, and at 355 nm, independently, with the laser system. A schematic of the mission concept drawing for the ACE mission is depicted in FIG. 5 and shows the various instruments that can be used to carry out the mission.

In yet another embodiment of the present invention, a method of analyzing ocean color biosphere measurements is provided. The method comprises generating pulsed laser beams with a laser system as described herein, directing the pulsed laser beams from a spacecraft toward a water-covered surface of the Earth, detecting reflected laser light returning to the spacecraft after reflecting off of the water-covered surface, and analyzing ocean color biosphere measurements based on the detected reflected laser light. In some embodiments, the generating and directing comprises producing 1 J TEM₀₀ laser pulses at 1064 nm, at 532 nm, and at 355 nm, independently, with the laser system.

### The HEATH Laser Transmitter

High Efficiency Amplified Twin Head (HEATH) laser system of the present invention is a next-generation, Joule-class, single-frequency stabilized, diode-pumped solid state laser (DPSSL) transmitter. Joule-level output production is provided through the configuration of the present invention, which accounts for the myriad of issues associated with the high nonlinear and self-damaging effects of these energies. It is also critical that effort be performed with an architecture designed to eventually meet the stringent thermal, power, reliability, and cost restrictions for flight. Leveraging research performed on both the oscillator and amplifier stages from the Laser Risk Reduction Program (LRRP), viable laser technology can be produced with proven high-power scalability that will satisfy the current performance requirements for both the 3D Winds and ACE missions.

A method to configure and optimize a laser system according to various embodiments of the present invention, includes the following procedures:

1. Seed, stabilize, and lock the THEO cavity for single frequency operation;

2. Amplify THEO's 1064 nm output to 500 mJ by a twin head preamplifier stage, for example, by using a large version of the THEO gain assembly;

3. Frequency double the output to 532 nm and record the ACE data set;

4. Replace the doubler with a larger, optimized power amplifier to achieve 1 Joule/pulse operation; and

5. Install the frequency doubling and tripling optics to achieve 3D Winds transmitter requirements.

The spectral stability, the pointing sensitivity, and TEM₀₀ beam quality can be defined by the oscillator portion of any MOPA system, however, an advantage of the laser system of the present invention is the high power capability and excellent beam quality. The HEATH architecture requires a minimum number of components, support optics, and hardware. These component savings greatly contribute to a reduced thermal load, associated costs, complexity, and minimized spatial noise and diffraction effects in the beam. Every optical component in a flight laser increases the overall cost in manpower and material, especially when considering the number of spare parts required. Furthermore, it is standard practice to minimize the total length of high index glass in a pulsed laser beam's path to reduce nonlinear, dispersive, and diffraction effects. The HEATH laser system of the present invention can have an equivalent number of slabs as a similarly powered MOPA, but the total slab gain path is far shorter and its reduced optical component count greatly contributes to this advantage as well.

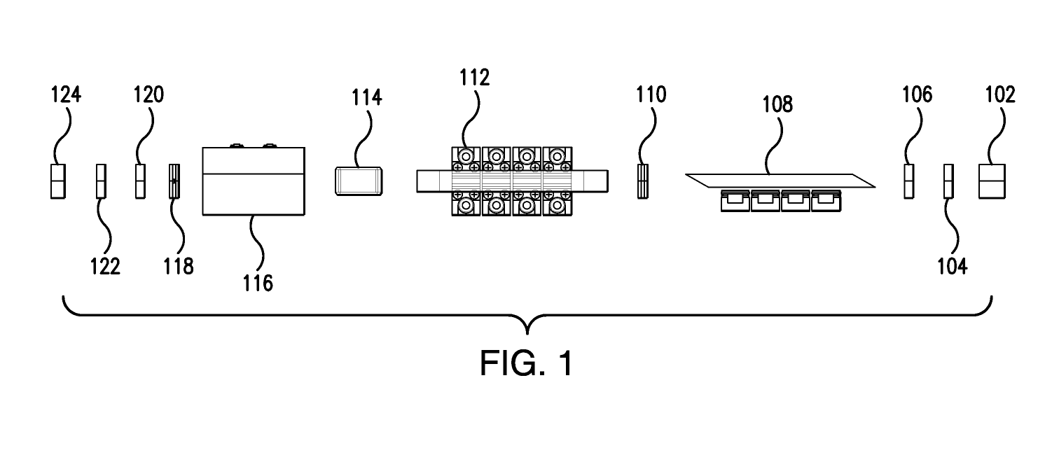

According to various embodiments of the present invention, the laser system comprises a twin head efficient oscillator, for example, as shown in the embodiments depicted in FIGS. 1, 2, and 6. The master oscillator provides advantages including a low parts count and the provision of a long mission lifetime. The laser system also comprises a dual-head pre-amplifier that is highly efficient and includes built-in thermal compensation features. In addition, the laser system comprises a ceramic power amplifier that includes a ceramic gain medium that helps mitigate thermal lensing effects. These three components are shown in an operable configuration as parts of the laser system shown in FIG. 4.

### Twin-Head Efficient Oscillator (THEO) Laser

A first example of the twin head efficient oscillator is shown in FIG. 1 and comprises a gain module comprising or consisting of a pair of laser head assemblies 108, 112, each having a crossed 8-bounce zigzag Nd:YAG slab, each pumped with four, 6-bar LDAs and rotated 90° with respect to each other, around the cavity beam axis. A Risley pair 104, 106 is positioned near a high reflectivity (HR) mirror 102 but the pair can be replaced with an adjustable HR mount. A ½ waveplate 110 is positioned between laser head assemblies 108 and 112, and a ¼ waveplate can be positioned between laser head assembly 112 and a Q-switch 116. Another Risley pair 120, 122 is positioned adjacent to the terminal HF mirror 124 and a ¼ waveplate 118 is provided between Q-switch 116 and Risley pair 120, 122. ¼ waveplate 118 rotates light's polarization by 45 degrees or 90 degrees after two passes. ¼ waveplate 118 together with Q-switch 116 and thin film polarizer 114 create the short Q-switched laser pulse. The configuration can be coupled with a positive branch unstable resonator (PBUR) and a gradient reflectivity mirror (GRM) output coupler. The positive branch unstable resonator refers to a laser cavity consisting of concave and convex mirrors, set a distance apart such that the laser beam formed within the cavity will grow in cross section (beam size) by a fixed magnitude, or magnification, with each round trip between the mirrors. A “stable” cavity will reproduce the identical beam size with each round trip. The gradient reflectively mirror is a coated mirror where the reflectivity of the coating changes with the radius of the surface. The reflectivity profile of the coated surface follows a Gaussian profile, where the peak reflectivity lies at the center of the optic, and goes to zero following a gaussian profile. The shape and diameter of this coating profile, can be matched to the gain volume and cross section of the laser slabs, the cavity length, and the curvature of the high reflective mirror at the opposite cavity end, to produce a symmetrical efficient laser beam.

Master Oscillator and Enclosure

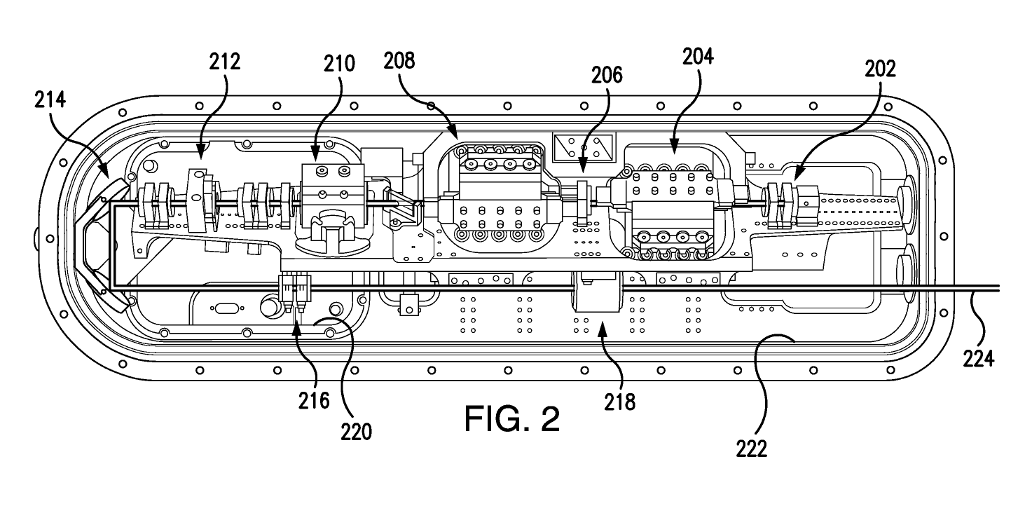

FIG. 2 is a plain view of a THEO master oscillator and an enclosure, in accordance with various embodiments of the present invention, wherein the lid of the enclosure is removed. When the lid is attached to the bottom part of the enclosure that is shown, a dual o-ring seal 222 seals the lid to the bottom. Within the enclosure are mounted a high reflectivity mirror and a pair of Risley optics, collectively denoted by reference numeral 202. The high reflectivity mirror and Risley optics are aligned to shape and reflect a laser beam produced by a first laser head assembly 204 and a second laser head assembly 208. A ½ waveplate 206 is positioned between laser head assembly 204 and laser head assembly 208. A Q-switch 210 is provided, and pulses exiting Q-switch 210 are shaped by optics including a ¼ waveplate 212 aligned along an optical path of generated laser beams. A set of beam folding mirrors 214 are provided to direct laser pulses through another pair of Risley optics 216 and into a beam expander/reducer 218 from which laser beam pulses 224 are directed through an aperture and out of the enclosure. FIG. 2 also shows a portion 220 of the enclosure referred to as a Q-switch driver enclosure.

### Long Term Test

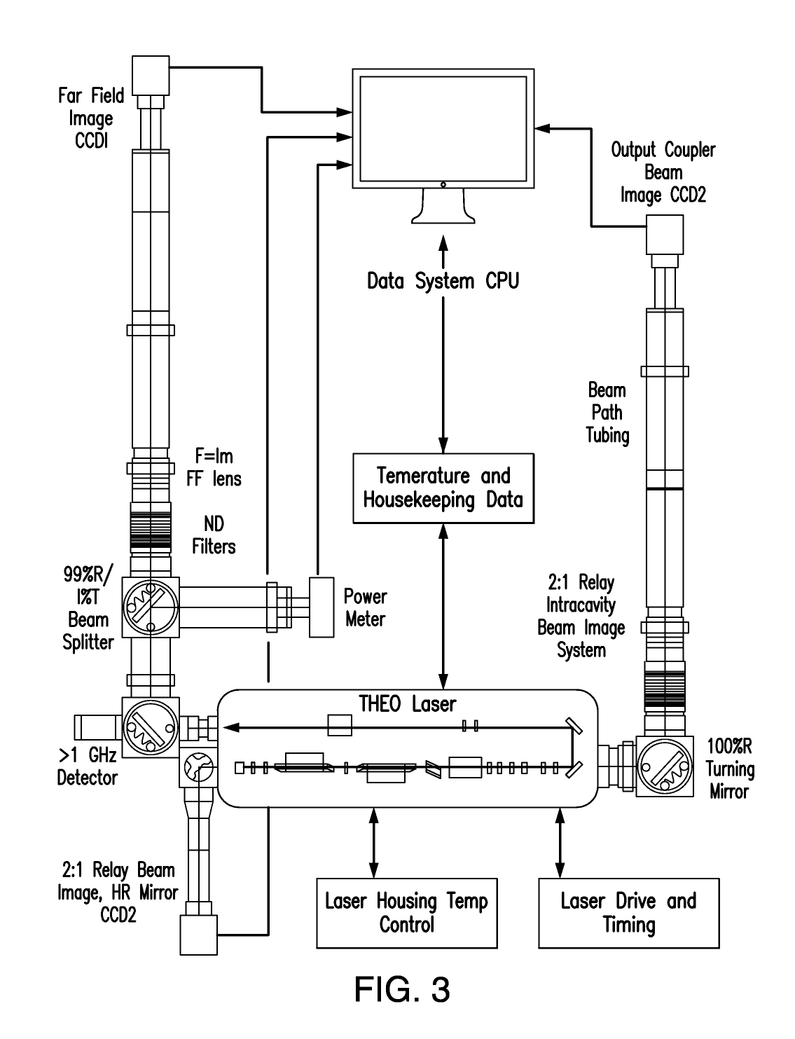

An automated testing installation was developed to operate the THEO system over the course of several months. The long term testing layout is detailed in FIG. 3. THEO is shown in the center, with several characterization real time measurements. To the lower left is the HR cavity mirror. The output window was large enough to allow a 2:1 relay imaging telescope to capture the intra-cavity beam cross section as it exists just before the 1^{st} last slab. The 0.1% loss shows that this mirror was more than enough to capture these images on a CCD. The beam exiting to the right is another intra-cavity beam measurement through the right angle folding mirror after the GRM output coupler. This again used a 2:1 relay optic setup to image the beam cross section just before the 2^{nd} laser slab face. To track the far field beam quality, Q-switched pulse width, and pulse energy, the folded full power output beam exits via the left end of the enclosure and sent to the corresponding instruments. A 1 m focal length lens was used to focus a <1% leaked beam on a CCD set at exactly 1 m from the lens, and thus the far field divergence was calculated by the software. Anodized 2 in. diameter aluminum tubes fully encompassed the beam paths to ensure safe unattended operation as well as to remove any air movement throughout the CCD systems which could add noise to the long term measurements.

The THEO laser operated at a significantly derated specification in this experiment, and yet produced >100 mJ per pulse at 100 Hz repetition rate for over 2×10⁹ shots with zero degradation in pulse energy.

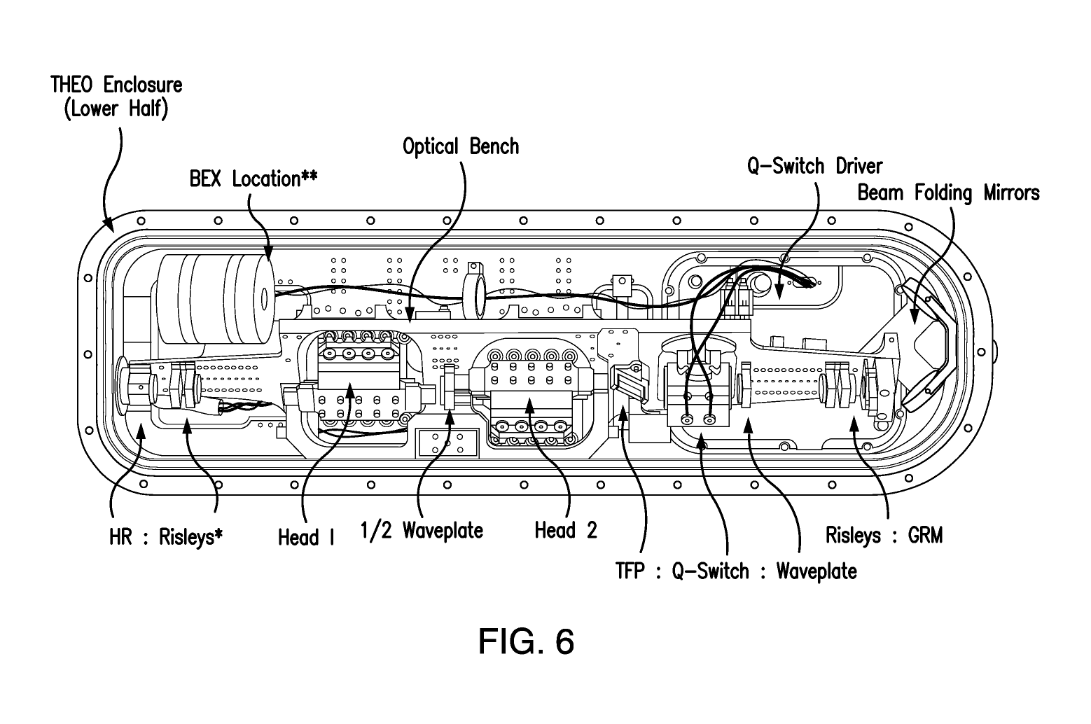

A similar but slightly different master oscillator in an enclosure is depicted in FIG. 6 which shows a preferred embodiment of the master oscillator, according to various embodiments of the present invention. The system shown in FIG. 6 is referred to herein as a 100 mJ Twin Head Efficient Oscillator (THEO) laser and produces 100 mJ pulses. In some embodiments, the Risley lens pair shown in FIG. 6, denoted by the single asterisk (*), and shown adjacent the high reflectivity mirror (HR), can be replaced with an adjustable HR mount. Also, in FIG. 6, the BEX location denoted by the double asterisks (**) shows where a frequency doubler can be located but has been removed in this particular embodiment.

The laser shown in FIG. 6 can produce a 100 Hz stream of TEM₀₀ 108 mJ pulses, 9.5 ns in width, at a 1064 nm wavelength throughout the life of a billion-shot test run. This list of specifications can only be produced with MOPA systems if up to 3× the components and a larger hardware footprint are used. After 1 billion pulses, there exists no measurable decay. The THEO optical efficiency is over 21%, which translates to over 8% electrical-optical with flight electronics, assuming a conservative LDA efficiency of 50% and a LDA drive electronics efficiency of 82% (28V bus voltage−LDA drive current pulses). This outcome is more than 2× that measured for the 100 mJ GLAS MOPA ETU but with about one-third the optical components and identical LDA driver values. As 0.5 J/pulse (ACE) and 1.0 J/pulse (3D Winds) capabilities are implemented, the calculated optical and wallplug efficiencies will improve to over 36% and 14.5%, respectively. The THEO cavity's large TEM00 beam quality is an excellent foundation on which to use a high power amplification process, and serves as the “engine” of the HEATH architecture of the present invention. The spatial beam parameters can be optimized and the performance tuned to produce >120 mJ pulses injection-seeded with a single highly stable external source, and cavity locked for single frequency operation.

### Twin Head Gain Architecture

Cylindrical laser rods create cleaner pumping distributions, and typically better beam qualities, over zigzag slabs. However, rods almost always require direct liquid-contact cooling surrounding the crystal, and are limited in extraction efficiency. The zigzag slabs used in accordance with the present invention provide much easier diode pumping parameters, simpler thermal and mechanical engineering, and better extraction efficiency. Two major issues are always present with DPSSL architectures based on trapezoidal, or “zigzag”, laser slabs. These are (1) thermal lens compensation and (2) heat removal from, or thermal control of, the laser head. These thermal effects are controlled, however, according to various embodiments of the present invention.

Typically, high power laser diode arrays are aligned along one long (pump) face of the slab, and the slab is thermally bonded to a thermally conductive “heat sink” on the opposing or long face. The end faces are the optical faces through which the evolved laser cavity beam will travel. The steady state thermal properties of the slab created by the heat production (diode pumping), the heat removal (heat sink), and the radiative cooling (optical energy extraction), within the slab create optical distortions and must be carefully corrected for good performance. These distortions increase exponentially as the laser fluence ramps up, as does the difficulty in their compensation. Zigzag slabs produce asymmetrical thermal lens effects requiring passive optic compensation, and create poor multimode beam quality, which combine to severely limit the average power and/or repetition rates. Longer, higher aspect ratio slabs for higher pulse energies will begin to bend or “potato chip” due to the asymmetric heating, as well.

The THEO-derived twin-head gain module of the present invention greatly reduces thermal effects, requires no passive optics, and requires no diffractive hard apertures. This technology offers unmatched performance for high power, zigzag slab-based cavities and higher power amplification.

The 1 Joule HEATH laser can use on a Master Oscillator Power Amplifier (MOPA), but with the THEO pumping incorporated throughout. This approach raises the bar for system efficiencies, produces a transmitter with a low number of components, and creates an excellent beam.

### Single Frequency Injection Seeding and Cavity Locking

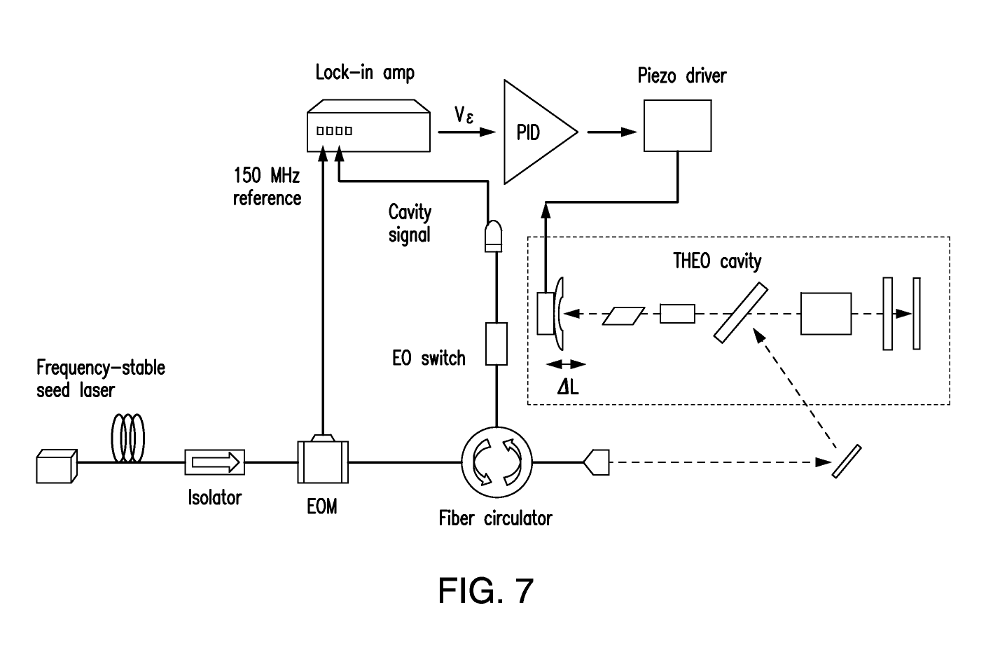

A schematic of a stabilization scheme that can be employed is shown in FIG. 7. The THEO oscillator can be seeded by a stable, isolated, fiber coupled 1064 nm seed source with fundamental frequency stability of better than 1 MHz for 30 seconds and 5 MHz for 60 minutes. The seed signal can be modulated @ 150 MHz and fed into the resonator where the round trip return beam is fed into a lock-in amplifier, where the sideband information is compared to that of the modulated signal. An error signal is fed into the piezo-controlled HR mirror mount that holds the cavity length resonant with the seed beam frequency. This configuration was successfully used to stabilized the laser to 3.8 MHz over 5 minutes, easily meeting any requirement of 5 MHz over 30 seconds.

### Preamplifier

The THEO master oscillator produces 120 mJ, single frequency laser pulses that can be sent into the amplifier stages of the architecture where precision defocusing of the beam expander after the THEO master oscillator produces a small divergence that can compensate for larger slabs and maintain the fluence at a safe level. As can be seen in FIG. 4, two amplification stages are provided. A dual head pre-amplifier comprises or consists of a twin head gain configuration as in the THEO master oscillator. This pre-amp takes the energy from the master oscillator stage and amplifies the signal 4× to produce about 500 mJ. Herein, by “about 500 mJ” what is meant is from 475 mJ to 525 mJ, including, for example, 480 mJ. To accomplish this, the pre-amp uses one more 6-bar LDA per slab than the THEO master oscillator, and slightly larger Nd:YAG slabs. The pre-amp then double-passes the gain path for maximized energy extraction, easy thermal lens correction, and minimal negative beam quality effects. When a twin-head unit is used as a 2-pass amplifier, the same type of beam correction can be performed with a return HR mirror.

The beam size can be carefully monitored and modeled throughout this stage for fluence damage mitigation. As the beam is amplified the HR mirror's prescription can be changed to allow the beam to grow to maintain a fluence level below damage thresholds. Another advantage of the double-pass configuration is that it allows for slightly lower pump powers than those needed over equivalent single-pass amplification, improved LDA derating, and the ability to fine tune its performance with greater accuracy. The natural polarized performance of zigzag slab end faces, however, naturally rejects one polarization over the other, and thus prevents use of a 2-pass polarization-coupled amplifier configuration. The preamp slabs' Brewster-cut end faces can be coated with a high damage threshold anti-reflection (AR) coating that is polarization independent. The AR coating performs identically with any polarization and is specially made to resist high field intensity laser fluencies.

### Power Amplifier

The 120 mJ Q-switched laser pulses can be scaled up by a total factor of about 8.5, while maintaining excellent beam quality and high pointing stability for final frequency doubling and tripling. The 500 mJ beam from the pre-amp stage can be carefully monitored in order to assure that fluence levels stay under control before it is steadily amplified another 2× to achieve about 1 J, or greater, energy out of the final stage. Herein, “about 1 J” refers to pulse energies at 1064 nm of from 750 mJ to 1.25 J. The power amplifier ceramic zigzag slab, unlike smaller twin head preamp slabs, can be pumped from opposite sides with thermal conduction surfaces on both un-pumped surfaces.

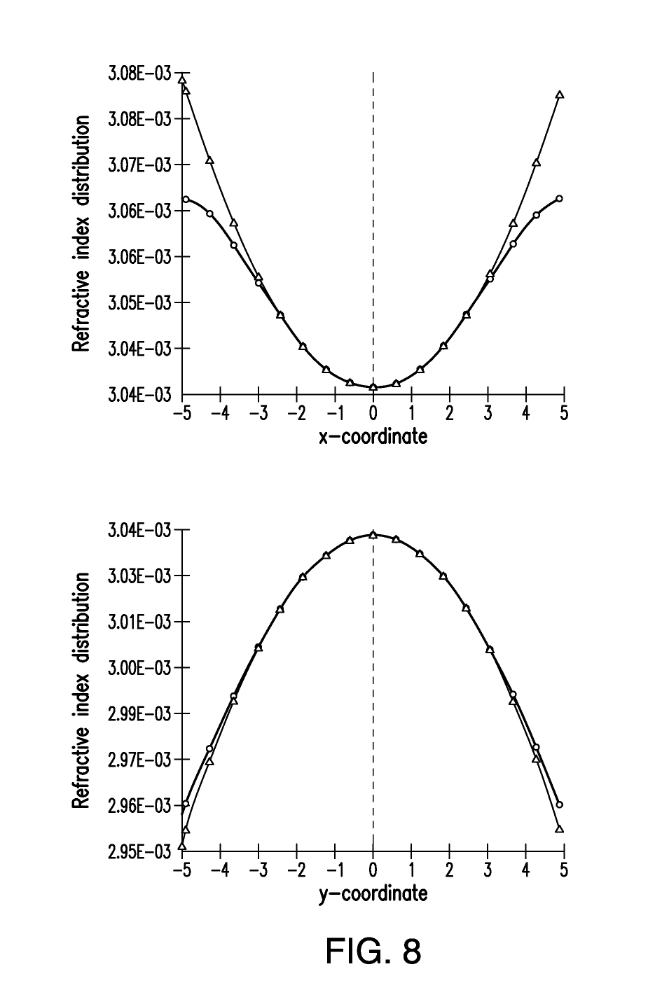

According to various embodiments, 18-bar LDAs and large zigzag slab material can be used. For side pumped zigzag slabs greater than 5 mm in width, pumping can be provided from opposing faces, and each LDA can be placed at each zigzag bounce point. There is a crossover point as slab thickness grows where all the pump absorption is biased toward the pump face and no gain exists on the opposing face, and thus too much slab warping occurs. The power amp can implement this opposing face, bounce-point pumping technique and the slab can be thermally mounted on the top and bottom faces. Initial analysis can be performed to see if the X and Y thermal lensing effects (pump axis and normal axis, respectively) are within reason and allows for safe, reliable, optical correction. These results are seen in FIG. 8, which shows a positive lens in the Y-axis and a negative lens in the X-axis, as expected. Also an experimental trade study can be used to compare ceramic and tradition crystal gain mediums for the power amplifier stage. The ceramic slab can give a lower thermal lensing effect. This allows more ready control of beam sizes in the slab, mitigating fluence-based damage effects.

### Frequency Conversion

Once 1 Joule pulse energies are achieved, the total system can be optimized for stable operation. In some embodiments the pulse energy achieved can be from about 750 mJ to about 1.25 J. Once the best possible TEM00 beam quality is consistent, intensity calculations can be checked to configure the best beam size for a certain operation. Great care can be taken to determine the precise beam setting for optimum performance. If the beam's cross section is too large and there is a reduced intensity within the nonlinear crystal, then the conversion efficiency will be low. The performance ramps up quickly with intensity, care can be taken not to induce damage in the pursuit of higher powers of 532 nm and 355 nm.

### Comparative Technology Assessment

When considering space flight transmitters, higher energy space-borne LIDARs such as the Geoscience Laser Altimeter System (GLAS), based on a master oscillator power amplifier (MOPA) architecture, have not fared well in terms of operational lifetime. All three laser transmitters aboard the instrument showed a high rate of decay in both the 1064 nm and 532 nm channels with respect to the required 3-year mission lifetime. Given that both ACE and 3D-Winds will require between 5 and 10 times greater pulse energies at 1 μm with more than twice the repetition rate, the significant advances in reliability, lifetime, and developmental cost reductions achieved by the present invention become even more surprising and unexpected. As diode pumped solid-state laser (DPSSL) powers increase, significant improvements in optical efficiency are needed and are provided according to the present invention.

The European Space Agency's ADM-AEOLUS wind LIDAR transmitter produces 1064 nm pulses of 500 mJ at 1064 nm prior to doubling and tripling. Even though the laser is state of the art, its high thermal load and bus power requirements demand that it must operate in a periodic burst mode. Its final output will be a 12 second run of 130 mJ at 355 nm, which includes a 5 second warm-up and 7 seconds of data, and an “off” cycle time of 16 seconds, to increase lifetime and reduce power consumption. Thus, the reduction of system size, mass, and part count achieved by the present invention can be critical in the development of next-generation high energy DPSSLs at NASA to capitalize on a 3D Winds and ACE launch opportunity in order to gather the most data possible for the valuable committed resources.

Table 1 below shows a comparative summary of various high power remote sensing lasers, including the HEATH laser system of the present invention.

TABLE 1

| Parameter | CALIPSO* | ADM | GLOW | TWiLiTE | HEATH |
|---|---|---|---|---|---|
| Pulse Rate | 20 HZ | 100 Hz* | 50 Hz | 150 Hz | 100 Hz |
| Pulse Energy - 1064 nm | 110 mJ | 500 mJ | 135 mJ | 35 mJ | 1 J |
| Amplifier Stages | 0 | 2 | 2 | 0 | 2 |
| Laser Wavelength | 532 nm | 1064 nm | 1064 nm | 355 nm | 1064 nm |
| Electrical Efficiency | 2% | 4.5%** | 1.5% | 4% | 10% |
| Output Power | 2.2 W | 10.5 W avg | 6.8 W | 20 W | 100 W |
| | | 50 W peak | | | |
| Expected Lifetime | 2 × 10⁹ | 3.25 × 10⁹ | 1 × 10⁹ | 1 × 10⁹ | 10 × 10⁹ |

*in burst mode
**total efficiency estimated

As detailed in Table 1 above, the HEATH laser system of the present invention meets or exceeds virtually all the critical specifications for a number of comparable selected laser transmitters. For example, the present HEATH laser system surpasses the performance of oscillator-only architectures such as TWiLiTE and CALIPSO in pulse energy and average power while maintaining considerable advantages in efficiency and lifetime.

In addition, the HEATH laser system of the present invention compares quite favorably against high-power MOPAs such as the Space Winds Laser Transmitter and the current commercial GLOW laser for a number of reasons. First, the pulse energy of the enhanced THEO master oscillator is four times greater than that used in its closest competitor, the Space Winds Laser Transmitter (200 mJ vs. 50 mJ), reducing the pump power load of the amplifier slabs and allowing for outstanding energy extraction efficiency.

These improvements enable an efficiency gain of 2× that of GLOW, a leap in average output power more than 2× that of the Space Winds Laser Transmitter, and 10× the pulse energy of TWiLiTE, but with a single amplifier stage instead of three.

Each of the following references is incorporated herein in its entirety by reference.
1. Coyle D. B., Kay R. B., Stysley P. R., Poulios D., Efficient, reliable, long-lifetime, diode-pumped Nd:YAG laser for space-based vegetation topographical altimetry. Appl Opt 2004; 43: 5236-42.
2. Armandillo E., Norrie C., Cosentino A., Laporta P., Wazen P., Maine P., Diode-pumped high efficiency high-brightness Q-switched Nd:YAG slab laser. Opt Lett 1997; 22: 1168-70.
3. Smith D. E., Muhleman D. O., Ivanov A. B., Mars orbiter laser altimeter: experiment summary after the first year of global mapping of Mars. J Geophys Res E 2001; 106 (E10):23689-722.
4. Eggleston J. M., Kane T. J., Kuhn K., Unternahrer J., Byer R. L., The slab geometry laser-part I: theory. IEEE J Quantum Electron 1984; 20: 289-301.
5. Schutz B. E., Zwally H. J., Shuman C. A., Hancock D., DiMarzio J. P., Overview of the ICE Sat mission. Geophys Res Lett 2005; 32:L21801.1-L21801.4
6. Coyle D. B., Stysley P. R., Poulios D., Kay R. B., Highly efficient, dual head, 100 mJ TEM₀₀Nd:YAG oscillator. Opt Laser Technoly 2008; 40:435-40.
7. Qin W., Du C., Ruan S., 10.2-W Q-switched intra-cavity frequency-doubled
Nd:YVO₄/LBO red laser double-end-pumped by laser-diode-arrays. Opt Express 2007; 1 5(4): 1594-9.
8. Coyle D. B., Stysley, P., The high output maximum efficiency resonator (HOMER) development for long life, space based vegetation and surface imaging. In: Proceedings of the IEEE aerospace conf.; 2006.

The entire contents of all references cited in this disclosure are incorporated herein in their entireties, by reference. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether such ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present invention will be apparent to those skilled in the art from consideration of the present specification and practice of the present invention disclosed herein. It is intended that the present specification and examples be considered as exemplary only with a true scope and spirit of the invention being indicated by the following claims and equivalents thereof.

What is claimed is:

1. A laser system comprising a master oscillator, a pre-amplifier, a power amplifier, a beam doubler, and a beam tripler, wherein the pre-amplifier is optically aligned to receive and pre-amplify a laser beam generated by the master oscillator, the amplifier is optically aligned to receive a pre-amplified laser beam generated by the pre-amplifier, the beam doubler and beam tripler are optically aligned to double and triple, respectively, an amplified laser beam generated by the amplifier, and the laser system is configured to produce pulse energies at 1064 nm of about 1 J.

2. The laser system of claim 1, wherein the master oscillator consists essentially of the following components:
a laser head comprising a diode-side-pumped ND:YAG slab laser configured as a zig-zag slab gain medium, the laser head configured to produce a laser beam along an optical path;
a ½ wave-plate aligned along the optical path and configured to polarize a laser beam produced by the laser head to form a polarized laser beam;
a Q-switch aligned along the optical path and configured to pulse a polarized laser beam polarized by the ½ wave-plate;
a ¼ wave-plate aligned along the optical path and configured to polarize a pulsed and polarized laser beam formed by the Q-switch;
a graded reflectivity mirror aligned along the optical path and configured to partially reflect and partially transmit a polarized, pulsed and polarized laser beam produced by the ¼ wave-plate, and to form a reflected laser beam along a reflected optical path;
a cylindrical lens aligned along the reflected optical path and configured to focus a reflected laser beam; and
a high reflectivity mirror aligned along the reflected optical path and configured to reflect a focused reflected laser beam produced by the cylindrical lens.

3. The laser system of claim 2, wherein the master oscillator further comprises an enclosure that has a single aperture, and the single aperture is configured to transmit a polarized, pulsed and polarized laser beam from the graded reflectivity mirror along the optical path to be output from the enclosure.

4. The laser system of claim 1, wherein the pre-amplifier comprises a twin head gain configuration adapted to amplify, by four times, energy produced by the master oscillator.

5. The laser system of claim 4, wherein the master oscillator is configured to produce 120 mJ single frequency laser pulse signals and the pre-amplifier is configured to amplify the signals to produce amplified signals of about 500 mJ.

6. The laser system of claim 5, wherein the pre-amplifier comprises Nd:YAG slabs having Brewster-cut end faces coated with an anti-reflection coating.

7. The laser system of claim 5, wherein the power amplifier is configured to amplify by two times the amplified signals produced by the pre-amplifier.

8. The laser system of claim 1, wherein the amplifier comprises a ceramic zigzag slab and a configuration to provide pumping from opposite sides of the ceramic zigzag slab.

9. The laser system of claim 1, mounted in or on a spacecraft.

10. In combination, the laser system of claim 1 and a spacecraft, wherein the laser system is mounted in or on the spacecraft and is configured to direct laser beam pulses of about 1 J toward the Earth.

11. The combination of claim 10, configured to direct the laser beam pulses at a 532 nm wavelength toward the Earth.

12. The combination of claim 10, configured to direct the laser beam pulses at a 355 nm wavelength toward the Earth.

13. The combination of claim 10, wherein the laser system is configured to generate laser beams of three different wavelengths, independently.

14. The combination of claim 13, wherein the laser system is configured to independently generate laser beams at a wavelength of 1064 nm, laser beams at a wavelength of 532 nm, and laser beams at a wavelength of 355 nm.

15. The combination of claim 13, wherein the laser system is configured to switch between generating the laser beams at the three different wavelengths.

16. A method of forming 1 J laser pulses, comprising forming laser pulses with the laser system of claim 1.

17. A method of analyzing aerosol backscatter radiation, comprising:
generating and directing pulsed laser beams with the laser system of claim 1, from a spacecraft, toward an atmosphere over a surface of the Earth;
detecting reflected laser light returning to the spacecraft after reflecting off of the atmosphere; and
analyzing aerosol backscatter radiation caused by the atmosphere, based on the detected reflected laser light.

18. The method of claim 17, wherein the generating and directing comprises producing 1 J TEM₀₀ laser pulses at 1064 nm, at 532 nm, and at 355 nm, independently, with the laser system.

19. A method of analyzing ocean color biosphere measurements, comprising:
generating and directing pulsed laser beams with the laser system of claim 1, from a spacecraft, toward a water-covered surface of the Earth;
detecting reflected laser light returning to the spacecraft after reflecting off of the water-covered surface; and
analyzing ocean color biosphere measurements based on the detected reflected laser light.

20. The method of claim 19, wherein the generating and directing comprises producing 1 J TEM₀₀ laser pulses at 1064 nm, at 532 nm, and at 355 nm, independently, with the laser system.
